(19) United States
(12) Patent Application Publication
(10) Pub. No.: US 2014/0357248 A1
(43) Pub. Date: Dec. 4, 2014

(54) Apparatus and System for Interacting with a Vehicle and a Device in a Vehicle

(71) Applicant: Ford Global Technologies, LLC, Dearborn, MI (US)

(72) Inventors: Basavaraj Tonshal, Northville, MI (US); James Stewart Rankin, II, Novi, MI (US); Yifan Chen, Ann Arbor, MI (US); Gary Steven Strumolo, Canton, MI (US); Brigitte Frances Mora Richardson, West Bloomfield, MI (US); Scott Andrew Amman, Milford, MI (US); Gintaras Vincent Puskorius, Novi, MI (US)

(73) Assignee: Ford Global Technologies, LLC, Dearborn, MI (US)

(21) Appl. No.: 13/908,226

(22) Filed: Jun. 3, 2013

(51) Int. Cl. H04M 1/725

(52) U.S. Cl. CPC H04M 1/72569; H04M 1/72577
USPC 455/418; 455/556.1

(57) ABSTRACT

A vehicle interface module configured to communicate with a nomadic device and a vehicle. The vehicle interface module comprising a wireless transceiver configured to communicate with a nomadic device and a vehicle transceiver configured to communicate with a vehicle data bus. The vehicle interface module also includes a processor configured to receive a signal from the vehicle data bus using the vehicle transceiver, wherein the signal was initiated by a user input to a vehicle computer system. Furthermore, the processor is also configured to determine that the signal prompts activation of a voice recognition session on the nomadic device, and provide input to the nomadic device using the wireless transceiver, wherein the input initiates a voice recognition session of the nomadic device.

### TECHNICAL FIELD

The illustrative embodiments generally relate to utilizing features of a mobile phone with a vehicle computer system.

### BACKGROUND

Apple, Inc. manufactures mobile phones and other portable electronics with Siri®, a intelligent personal assistant that helps users utilize voice commands to execute specific commands on the phone, such as sending text messages, scheduling meetings, placing phone calls, etc. Additionally, SIRI utilizes natural speech and may utilize a series of prompts to complete a user's request.

Apple, Inc. also integrates SIRI into voice control systems of vehicle manufactures through Apple's “Eyes Free” solution. By utilizing a voice command button on a steering wheel, a driver may be able to activate SIRI on a user's phone. Additionally, the device's screen may stay in sleep mode to minimize distractions.

U.S. Patent Application No. 2012/0245945 discloses an in-vehicle apparatus that receives an image data representative of a screen image from a portable terminal with a touch panel. The apparatus extracts a text code data from the image data, and identifies a text-code display area in the screen image. The apparatus determines a command text based on a user-uttered voice command. The apparatus identifies a text-code display area as a subject operation area in the screen image of the portable terminal, based on the command text, the text code data extracted from image data, and information on the text-code display area corresponding to the text code data. An area of the screen image of the touch panel corresponding to the text-code display area is identified as the subject operation area, and a signal indicative of the subject operation area identified is transmitted to the portable terminal.

### SUMMARY

A first illustrative embodiment discloses a vehicle interface module configured to communicate with a nomadic device and a vehicle. The vehicle interface module comprises a wireless transceiver configured to communicate with a nomadic device and a vehicle transceiver configured to communicate with a vehicle data bus. The vehicle interface module also includes a processor configured to receive a signal from the vehicle data bus using the vehicle transceiver, wherein the signal was initiated by a user input to a vehicle computer system. Furthermore, the processor is also configured to determine that the signal prompts activation of a voice recognition session on the nomadic device, and provide input to the nomadic device using the wireless transceiver, wherein the input initiates a voice recognition session of the nomadic device.

A second illustrative embodiment discloses a vehicle computing system comprising a wireless transceiver configured to pair with and establish a wireless connection to a nomadic device. The vehicle computer system also includes a port capable of sending vehicles messages to a vehicle interface module, the vehicle interface module configured to communicate with the nomadic device and receive data from a data bus of the vehicle. The vehicle computer system also includes a processor configured to send a signal from a vehicle input to the vehicle interface module, wherein the vehicle interface module determines that the signal triggers initiation of a voice recognition system of the nomadic device and activates the voice recognition system of the nomadic device based on the signal from the vehicle input. The processor is also configured to receive a voice request from a user via a vehicle microphone, send the voice request to the nomadic device utilizing the wireless transceiver, receive a response to the voice request from the nomadic device, wherein the response is processed by the nomadic device or a server in communication with the nomadic device, output the response to the voice request utilizing a vehicle speaker.

A third illustrative embodiment discloses a vehicle interface module, comprising a wireless transceiver for communicating with a nomadic device and a vehicle transceiver for receiving information from a vehicle in communication with the nomadic device. The vehicle interface module also includes a processor configured to receive a signal from the vehicle transceiver, wherein the signal is initiated from a user input of the vehicle. The processor is also configured to convert the signal to a message, wherein the message activates a voice recognition system on the nomadic device, and send the message to the nomadic device.

### BRIEF DESCRIPTION OF THE DRAWINGS

FIG. 1 illustrates an example block topology for a vehicle based computing system for a vehicle.

FIG. 2 illustrates an example block topology of a vehicle based computing system utilizing a portable vehicle interface module to communicate with a mobile phone.

FIG. 3 illustrates an illustrative flow chart utilizing a vehicle based computing system in communication with a mobile phone.

FIG. 4 illustrates an example sequence diagram of a steering wheel interacting with an iOS device utilizing the vehicle interface module.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The invention now will be described more fully hereinafter with reference to the accompanying drawings, in which illustrative embodiments of the invention are shown. This invention, may however, be embodied in many different forms and should not be construed as limited to the embodiments set forth herein. Like numbers refer to elements throughout. As used herein the term “and/or” includes any and all combinations of one or more of the associated listed items.

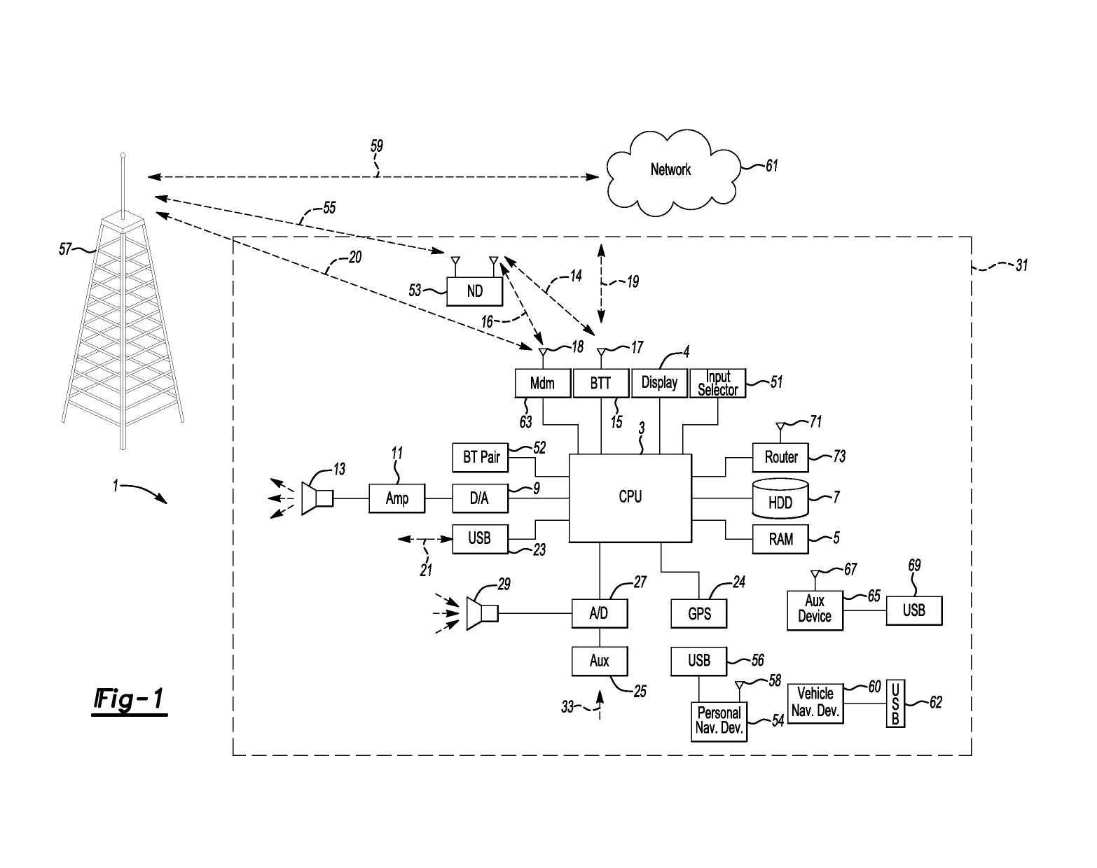

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to select between various inputs. Input to both the microphone and the auxiliary connector is converted from analog to digital by a converter 27 before being passed to the processor. Although not shown, these and other components may be in communication with the VCS over a vehicle multiplex network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, tablet, a device having wireless remote network connectivity, etc.). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, nomadic device, key fob and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

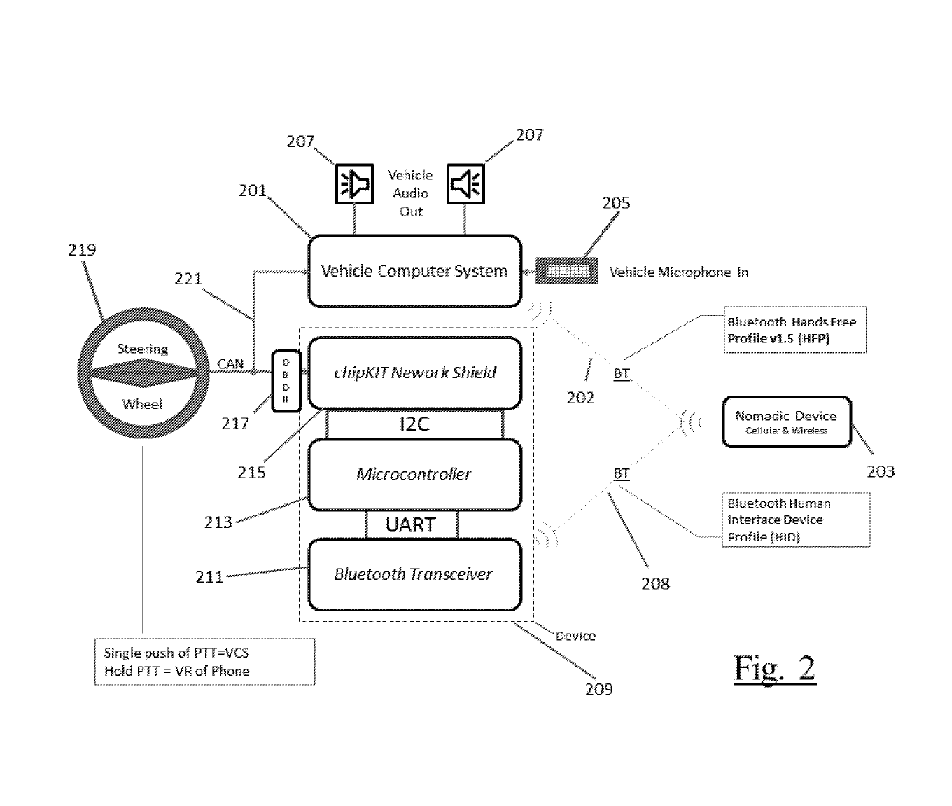

FIG. 2 illustrates an example block topology of a vehicle based computing system utilizing a wireless module to communicate with a nomadic device. A nomadic device 203 may be in communication with a VCS 201 and a vehicle interface module 209. The nomadic device may be in wired or wireless communication with both the VCS 201 and the vehicle interface module 209. In the illustrative embodiment of FIG. 2, the nomadic device 203 communicates with the VCS 201 via Bluetooth. Although the VCS may communicate data through wireless signals 202 to the nomadic device via a variety of Bluetooth profiles (i.e. HFP, A2DP, AVRCP, GAP, HID, etc), FIG. 2 shows an example utilizing the hands free profile. Additionally, FIG. 2 illustrates that the vehicle interface module 209 may communicate data through wireless signals 208 to the nomadic device via the human interface device profile, although any of the variety of Bluetooth profiles may also be accessible.

The VCS 201 may also use a vehicle microphone 205 for receiving voice input commands from a user. The voice input may be used in conjunction with a voice recognition system located on the VCS, the nomadic device, or on a remote network. The VCS may retrieve a voice recognition system via the remote network utilizing the nomadic device. The remote voice recognition may be retrieved utilizing the nomadic device's wireless transceiver (e.g. GSM, 3G, 4G, LTE, Wi-Fi, Wi-Max, etc). Upon the nomadic device retrieving the voice recognition system, the nomadic device may be able to send the voice recognition prompts or commands to the VCS via the wireless signal 202. The voice recognition prompts, as well as other output retrieved from the nomadic device or a remote server in communication with the nomadic device or VCS, may be output via the vehicle speakers 207 or other output (e.g. vehicle display, instrument cluster, etc). Additionally, the VCS may receive voice commands from the vehicle MIC 205 to send to the nomadic device or remote voice server via the wireless signal 202.

The VCS may be in communication with the vehicle interface module 209 that is plugged into the vehicle's on-board diagnostics (OBDII) port 217. The OBDII port may retrieve vehicle messages from the vehicle data bus 221. Although the vehicle interface module may be plugged into the OBDII port in the illustrative embodiment of the vehicle, the vehicle interface module may communicate with the vehicle bus via a serial port, USB transceiver, BT transceiver, or other interface. Further, the vehicle interface module may be portable or embedded in the vehicle. The vehicle's data bus may utilize standards such as CAN (Controller Area Network), MOST (Media oriented Systems Transport), or other bus protocol.

The vehicle interface module 209 may include a controller area network (CAN) support module 215, or another similar node on the vehicle bus network to retrieve diagnostic commands, messages, or other data from a vehicle's data bus. A microcontroller 213 may be utilized to aid in processing data retrieved from the CAN support module 215 and a wireless module. The wireless module 211 may be a Bluetooth module as exemplified in FIG. 2, or any other short-range communication module (either wired or wireless), such as a Wi-Fi transceiver, Wi-Max, USB, HDMI, RFID, etc. Additionally, the Bluetooth module 211 and microcontroller 213 may communicate amongst one another via a USB to UART connection. The Bluetooth module 211 may be used to communicate with the nomadic device 203 via the wireless signal 208. The wireless signal 208 may communicate utilizing the human interface device profile.

The microcontroller 213 may be utilized to determine when an activation signal is initiated. For example, the microcontroller 213 may determine that a press and hold of the PTT button should initiate a voice request session on the nomadic device. Upon a user pressing and holding the PTT skip button, the portable vehicle interface module may send a signal to the nomadic device mimicking a nomadic device's “HOME” button activate a voice recognition session. Although this embodiment activates a voice recognition session, the microcontroller may be used to mimic any interaction with the nomadic device via the HID profile. Thus, any application or function of the nomadic device may be utilized, not only a voice recognition session. For example, a third party application may be activated on the nomadic device utilize the vehicle interface module. Different vehicles may be able to utilize different activation signals to operate or launch applications on the nomadic device.

The microcontroller 213 may contain software to translate input from any vehicle, regardless of vehicle manufacturer, make, or model, to operate a function on any nomadic device. Thus, the portable vehicle interface module is vehicle independent. For example, the microcontroller may be configured process data from one make or model of a vehicle. The controller may decode the message received from the vehicle to determine that interaction with the nomadic device is requested and to begin activation of an application, such as a voice recognition session. The vehicle interface module may send one type of specific message during that vehicle's use of an input controller or input (i.e. press and hold a PTT button, double-tap a PTT button, single press a PTT button), while another make or model sends a different type of message during another specific use of the input controller. Regardless of the vehicle, the microcontroller may understand the message retrieved from the vehicle's data bus and initiate a specific input of the nomadic device if appropriate.

The portable vehicle interface module may be device independent as well. Thus, the microcontroller may be configured to send a specific command to the device based on the type of device (e.g. brand, model, software version, etc) and a different command for another device. For example, the portable vehicle interface module may mimic the press and hold of the home button to initiate voice recognition of one nomadic device. While interfacing with another nomadic device, the microcontroller may send a different command to instead mimic the nomadic device's interface by activating a double tap of the device's home button to initiate a voice recognition session. The portable vehicle interface module may determine which commands to send to the nomadic device to activate a specific feature that a user of the vehicle is requesting. The microcontroller may understand which messages to send to the nomadic device by utilizing Bluetooth (e.g.—the HID profile) or another type of protocol, API, software, etc.

In one embodiment, the voice recognition system may be initiated by utilizing a button on the steering wheel 219, or any other input device located in the vehicle (e.g. touch screen, hard-button, keyboard, haptic device, rotary knob, etc.). Upon activating a push to talk switch on the steering wheel 219, the input controller may send a message. Different vehicles may be able to utilize different activation signals via the vehicle's data bus 221 and vehicle bus transceiver 215. The input controller 219 signal may initiate the vehicle interface module 209 to begin activation of the nomadic device's voice recognition system based on the configuration of the microcontroller 213. Additionally, the input controller may also be capable of sending a signal to the VCS to begin detection via the vehicle MIC 205 for a voice command.

The input controller 219 may be capable of sending different commands to the vehicle interface module based on input method that may be defined by the user, microcontroller, vehicle manufacturer, etc. For example, a single press of the PTT button may initiate the voice recognition system of the VCS to be activated. However, the interface module may be configured in a manner that a press and hold may initiate the voice recognition of the nomadic device, or the voice recognition of the remote network in communication with the nomadic device. Additional input variations may be included, such as a triple-press, a double press and hold, a double tap, or any other combination to distinctly activate the different voice recognition systems of the VCS, nomadic device, and remote voice server in communication with the nomadic device, etc.

Additionally, an alternative embodiment may include an internal keyboard (e.g. built into the steering-wheel, the keyboard used on the multimedia display, etc) or external keyboard that may be utilized as an input controller. The keyboard may communicate with the vehicle or nomadic device utilizing a wired or wireless communication. The keyboard may be capable of initiating a voice request on the nomadic device 203 or the remote voice server in communication with the nomadic device. Additionally, the keyboard may be capable of sending additional input signals to the nomadic device via the vehicle interface module 209 to send data to the nomadic device 203. For example, a user may utilize the keyboard to type a text message, enter an address, operate the nomadic device's user interface, etc. Thus, a touch screen display of the VCS may be able to operate on a nomadic device as an input controller seamlessly. For example, the vehicle interface module may be capable of utilizing the input of the VCS to control the nomadic device. The nomadic device may be able to send interface data (e.g. the device's HMI or GUI) to the vehicle for output on the display. The user may then utilize inputs of the vehicle to control the nomadic device by sending commands through the vehicle interface module.

In another embodiment, the vehicle interface module may be utilized to send commands to devices in remote locations. The vehicle interface module may operate a remote device by utilizing the data connection of the nomadic device to send commands to the remote device. For example, appliances in a home may be in communication with an off-board server. A driver may be able to initiate a function or operate the home appliance by sending a signal from the VCS to the vehicle interface module and to the nomadic device. From the nomadic device, the signal may be sent to a remote server that is in communication with the appliance.

In alternative embodiments, the interface module may also retrieve software or firmware updates from the remote server. The vehicle interface module may include its own independent transceiver to communicate with the remote server, or utilize the VCS or the nomadic device to communicate with the remote server. The software or firmware updates may be utilized to update Bluetooth profiles, vehicle data bus translation, or other functionality.

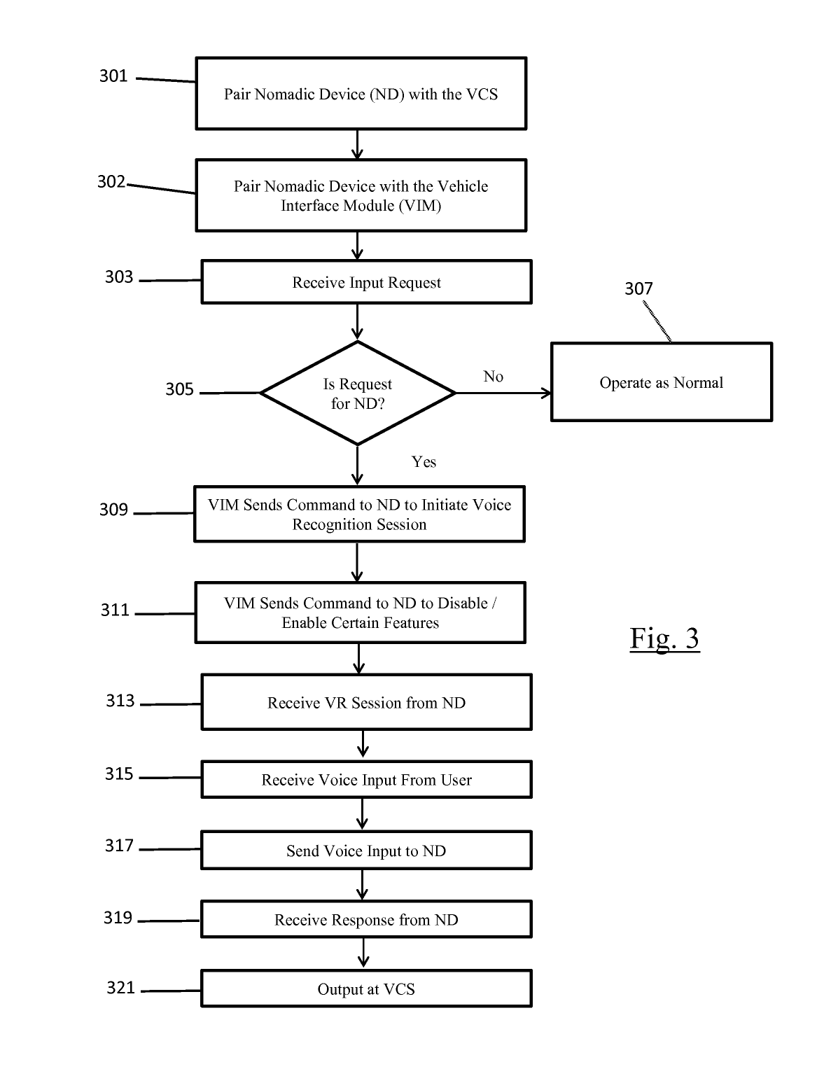

FIG. 3 shows an illustrative flow chart utilizing a vehicle based computing system in communication with a mobile phone. The VCS may utilize a Bluetooth transceiver to pair with a nomadic device 301, such as a mobile phone. The pairing process may utilize different Bluetooth profiles to facilitate communication between the VCS and the nomadic device. Some of these profiles may include HFP, A2DP, AVRCP, PBAP, HID, BVRA (part of the HFP profile), etc. The pairing process may be accomplished from either the mobile phone or the VCS.

Additionally, the VCS may be in communication with the portable vehicle interface module. The portable vehicle interface module may be installed into the OBDII port of a vehicle to retrieve messages from the vehicle data bus. The portable vehicle interface module may also pair with a nomadic device 302, such as a mobile phone. The pairing process may be accomplished from the mobile phone, the portable vehicle interface module, or the VCS. The portable vehicle interface module may communicate with the nomadic device utilizing different Bluetooth profile or wireless signals than those used by the VCS. For example, the portable vehicle interface module may communicate with the nomadic device via the HID profile, while the VCS may communicate with the nomadic device via the HFP profile. Additionally, the portable vehicle interface module may utilize a different wireless standard all together than the VCS to communicate with the nomadic device. In other embodiments, the portable vehicle interface module may utilize the same signals to communicate with both the VCS and the nomadic device, and they may also be wired.

The user may activate an input request that is determined by the vehicle interface module to begin a voice recognition (VR) session of the nomadic device. The VCS may be in communication with the input controller and receive an input request 303. The vehicle interface module may listen to the messages on the vehicle bus to determine when to initiate functions or applications on the nomadic device. The input may be activated via a steering wheel switch, touch screen, vehicle hard or soft button, switch, etc.

The vehicle interface module may determine if the input controller has initiated the request to begin a VR session, or another function or application, on the nomadic device. In certain embodiments, the interface module may be programmed to initiate the VR session request to the nomadic device by utilizing a unique operation, such as holding a push to talk (PTT) switch on the steering wheel. Alternatively, a simple press of the PTT switch may initiate a VR request to the VCS's voice recognition system to output to the user. Thus, the vehicle interface module may ignore commands deemed to be inapplicable to the nomadic device 307 and the VCS may operate the commands as normal.

Upon a request for initiating a VR session of the nomadic device phone, the VCS may communicate with the mobile phone via the portable vehicle interface module to initiate a request for a VR session 309. The VCS may send a message to the portable vehicle interface module. The portable vehicle interface module may then send a message or request to the nomadic device to initiate a VR session on the mobile phone or a remote voice application server, if the vehicle interface module determines the message should be converted and sent to the nomadic device. The interface module may control the nomadic device to mimic the device's interface upon receiving such a message. The portable vehicle interface module may communicate with the nomadic device via a wired or wireless connection (e.g. Bluetooth, Wi-Fi, Wi-Max, etc), while the VCS may utilize its own dedicated wireless connection with the nomadic device. In one embodiment, the VCS may utilize the portable vehicle interface module, which uses the HID profile, to communicate with the nomadic device for certain signals utilized to activate functions of the nomadic device. Additionally, the VCS may communicate with the nomadic device directly via the HFP profile. Thus, the VCS may maintain two separate Bluetooth connections with the nomadic device.

Although the VCS may initiate a VR session on the nomadic device via the interface module, additional functionality may be available for operation on the nomadic device. For example, the VCS may send a request to a nomadic device to disable or enable certain features 311. The VCS may send the request via the dedicated Bluetooth transceiver of the VCS, or via the portable vehicle interface module. For example, the VCS may utilize the portable vehicle interface module via the Bluetooth connection over the HID profile to request the nomadic device to disable the keyboard of the nomadic device. In alternative embodiments, the VCS may disable other features of the nomadic display, such as text messaging, the display, speakers, ringer, etc. Additionally, the features may be disabled at specific moment or condition (e.g. when the vehicle travels >3 MPH, when the vehicle is not in Park, or when the devices connect via Bluetooth with each other). The vehicle interface module or the VCS may send the request for enabling/disabling a feature to the nomadic device at any moment upon pairing with the nomadic device, not only as illustrated in the current embodiment. Thus, the flow chart should only be used as an example of the when the request is sent.

Furthermore, the VCS may be in communication with a keyboard or other input controller. The keyboard may be utilized to operate the nomadic device via the HID profile. Additional embodiments may utilize other input devices (mouse, haptic device, hard button, rotary knob, steering wheel controls, soft buttons on a touch screen, etc) to operate the user interface of the nomadic device.

The VCS may receive output related to the VR session from the nomadic phone 313 via the wireless connection. In one example, the nomadic device may retrieve information related to the VR session from a remote server. The information may include a voice guidance menu, a output response, off-board data (i.e. weather, sports, news, contact information, music data, etc.), etc. The nomadic device may output a response through the vehicle's speakers via the HFP profile connection. In other embodiments, the nomadic device may send data to the VCS for output on a vehicle display (e.g. Instrument Panel Cluster, Navigation Display, RSE) or other output terminals.

Upon the VR session initializing, the VCS may receive input from the user related to the session 315. The input may be a spoken voice request from a user retrieved by a vehicle mic or a nomadic device's mic. For example, upon the VR session being activated, a sound indicating the VR session has begun may be output over the vehicle speakers. The VR session may wait for input to be retrieved and activate the vehicle mic to receive input corresponding to the VR session. The voice input may be utilized to activate a command on the nomadic device. The input may also be a manual input utilizing a vehicle keyboard, touch screen, steering wheel switch, or other input controller (e.g. input controller communicating with the VCS or vehicle interface module via wired or wireless communication). The vehicle's input controller may be utilized to operate the nomadic device without physically having to interact directly with the nomadic device. Thus, the nomadic device may be out of reach to a user, but a user can operate the device via the VCS.

The VCS may send the input to the nomadic device 317. The input may be sent via a wired or wireless connection via the VCS, or may even utilize the portable vehicle interface module in other embodiments. In one embodiment, the VCS may send the voice request via the HFP profile to the nomadic device. For example, the VCS may receive voice input from a user utilizing the vehicle mic, and send that voice input to a cellular phone utilizing Bluetooth. Additional data may be sent to the nomadic device to enable or disable features of the nomadic device, as well.

The nomadic device may utilize the voice request and process the voice request locally on the nomadic device or send the voice request off-board to a remote voice application server. The nomadic device may utilize a hybrid solution where certain voice requests are processed onboard (e.g. a voice request dealing with contact information or music data stored on the nomadic device) and others are done remotely (e.g. utilizing off-board data or off-board processing capabilities). Several operating systems of mobile phones utilize voice recognition solutions that may be used in conjunction with certain embodiments, such as iOS's SIRI or Android's Google Voice Recognition. Third-party voice recognition applications may also be utilized by the nomadic device. The VCS may receive a response from the nomadic device utilizing the HFP profile of the phone. For example, a VCS may have activated a phone to process a voice request to check the weather. The mobile phone, or a server in communication with the phone, may have processed the voice request. Upon the phone retrieve a response, the phone may send the response to the VCS via the HFP profile.

Upon retrieving the response from a nomadic device 319, the VCS may output the response 321. In one example, the VCS may output a response from the VR session via the vehicle's speakers. In another embodiment, the VCS may output a response via the vehicle display utilizing a different profile. The response may require additional input by the user or may simply out the user's request.

Although exemplary processes and methods are shown herein, it is understood that these are for illustrative purposes only. One of ordinary skill would understand that the steps thereof could be performed in any suitable order to produce the desired results. Further, one of ordinary skill would understand that some and/or all of the steps could be replaced by similar processes that produce similar results and/or removed if not necessary to produce the desired results in accordance with the illustrative embodiments.

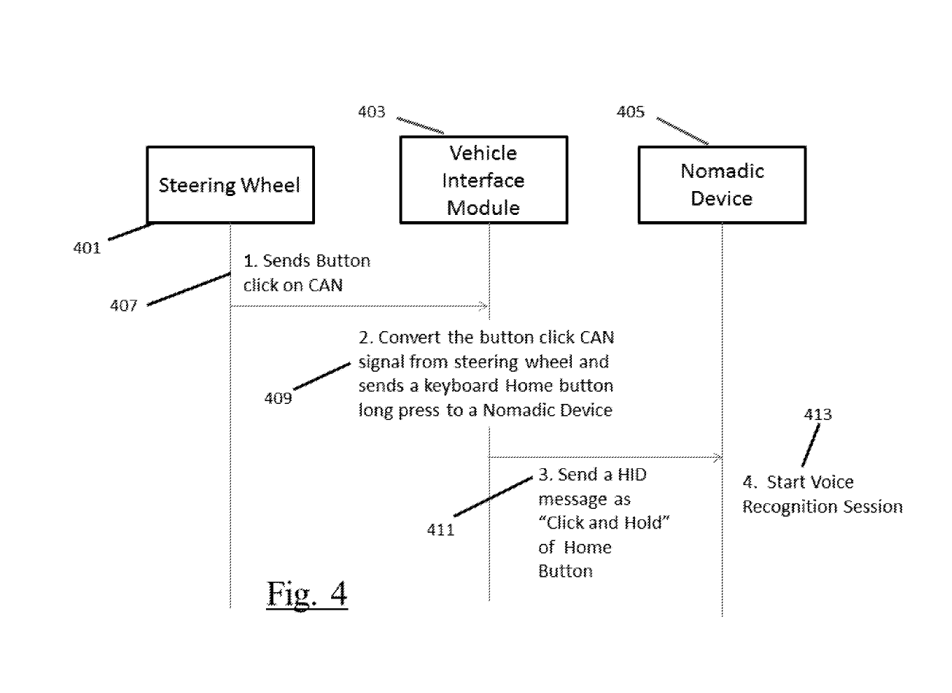

FIG. 4 illustrates an example sequence diagram of a steering wheel interacting with an iOS device utilizing the vehicle interface module. The non-limiting example utilizes a steering wheel input, a vehicle interface device, and a nomadic device utilizing the iOS operating system as the software running on the nomadic device. One of ordinary skill in the art may utilize different devices than those disclosed below and produce similar results.

The VCS may be in communication with an input controller such as a steering wheel switch 401. Upon the user activating the steering wheel switch (e.g. hold the PTT button), the steering wheel sends a “Button Click” message on the CAN bus. 407 The “Button Click” message is retrieved by the vehicle interface device 403 via the vehicle's CAN bus.

The vehicle interface device 403 may receive the message from the steering wheel switch, or other VCS component. The vehicle interface device may understand that the specific action by the user is meant to initiate functionality on the nomadic device. The vehicle interface device 403 may convert the “Button Click” CAN signal from the steering wheel key into a “Home Button Long Press” to the nomadic device 409. Thus, the “Home Button Long Press” may be utilized to activate a voice recognition session. The vehicle interface module may convert messages from any type of vehicle (including boats, motorcycles, planes, etc) to any type of device in communication with the interface module.

The vehicle interface device 403 may send a message via the HID Bluetooth profile to the nomadic device 411. The HID message may be a “Click and Hold” of the nomadic device's Home button, which in turn may activate a voice recognition session (eg. SIRI of an iOS device). Thus, the nomadic device 405 may begin the voice recognition session 413. Once the voice recognition session begins, the nomadic device may communicate with the VCS utilizing a wireless connection (e.g. HFP profile) to send/receive data or information related to the voice request of the user.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle interface module configured to communicate with a nomadic device and a vehicle, comprising:
a wireless transceiver configured to communicate with a nomadic device;
a vehicle transceiver configured to communicate with a vehicle data bus; and
a processor configured to:
1.) receive a signal from the vehicle data bus using the vehicle transceiver, wherein the signal was initiated by a user input to a vehicle computer system;
2.) determine that the signal prompts activation of a voice recognition session on the nomadic device; and
3.) provide input to the nomadic device using the wireless transceiver, wherein the input initiates a voice recognition session of the nomadic device.

2. The vehicle interface module of claim 1, wherein the processor is further configured to send via the wireless transceiver a request to the nomadic device to enable or disable an input or output of the nomadic device.

3. The vehicle interface module of claim 2, wherein the request includes disabling a keyboard of the nomadic device.

4. The vehicle interface module of claim 2, wherein the request includes disabling a screen of the nomadic device.

5. The vehicle interface module of claim 1, wherein the vehicle interface module is further configured to install into an on-board diagnostic port of a vehicle.

6. The vehicle interface module of claim 1, wherein the wireless transceiver utilizes a Bluetooth connection with a human interface device profile to communicate with the nomadic device.

7. The vehicle interface module of claim 1, wherein the vehicle interface module provides input to the nomadic device using a human interface device profile.

8. The vehicle interface module of claim 1, wherein the processor is further configured to determine initiation of applications on different nomadic devices based on the signal received from the vehicle data bus.

9. The vehicle interface module of claim 1, wherein the vehicle interface module is portable.

10. The vehicle interface module of claim 1, wherein the nomadic device is a tablet, mobile phone, or music player.

11. A vehicle computing system, comprising:
a wireless transceiver configured to pair with and establish a wireless connection to a nomadic device;
a port capable of sending vehicles messages to a vehicle interface module, the vehicle interface module configured to communicate with the nomadic device and receive data from a data bus of the vehicle; and
a processor configured to:
send a signal from a vehicle input to the vehicle interface module, wherein the vehicle interface module determines that the signal triggers initiation of a voice recognition system of the nomadic device and activates the voice recognition system of the nomadic device based on the signal from the vehicle input;
receive a voice request from a user via a vehicle microphone;
send the voice request to the nomadic device utilizing the wireless transceiver;
receive a response to the voice request from the nomadic device, wherein the response is processed by the nomadic device or a server in communication with the nomadic device;
output the response to the voice request utilizing a vehicle speaker.

12. The vehicle computing system of claim 11, wherein the wireless transceiver for communication with a nomadic device is a Bluetooth transceiver.

13. The vehicle computing system of claim 11, wherein the vehicle interface module activates the voice recognition system using a different signal than the signal from the vehicle input.

14. The vehicle computing system of claim 11, wherein the vehicle interface module communicates with the nomadic device utilizing the human interface device (HID) profile of the Bluetooth protocol.

15. The vehicle computing system of claim 11, wherein the processor is further configured to send a request to vehicle interface module to disable a keyboard of the nomadic device upon activation of the voice recognition system.

16. The vehicle computing system of claim 11, wherein the port is an on-board diagnostic port, USB port, or Serial Port.

17. The vehicle computing system of claim 11, wherein the vehicle interface module activates the voice recognition system of the nomadic device via a Bluetooth connection.

18. A portable vehicle interface module, comprising:
a wireless transceiver for communicating with a nomadic device (ND);
a vehicle transceiver for receiving information from a vehicle in communication with the ND;
a processor configured to:
receive a signal from the vehicle transceiver, wherein the signal is initiated from a user input of the vehicle;
convert the signal to a message that activates a voice recognition system on the ND; and
send the message to the ND.

19. The portable vehicle interface module of claim 18, wherein the message is further configured to mimic operation of an input on the nomadic device.

20. The portable vehicle interface module of claim 18, wherein the processor is further configured to send via the wireless transceiver a request to the nomadic device to enable or disable an input or output of the nomadic device.
